(19) United States
(12) Patent Application Publication
(10) Pub. No.: US 2004/0191390 A1
(43) Pub. Date: Sep. 30, 2004

(54) Encapsulated oil and fat products with free fatty acids

(76) Inventor: John H. Lee, Olathe, KS (US)

Correspondence Address: John H. Lee, 1441 N Lucy Montgomery Way, Olathe, KS, 66061, US

(21) Appl. No.: 10/401,384

(22) Filed: Mar. 31, 2003

(51) Int. Cl. A23L 1/00

(52) U.S. Cl. 426/601; 426/89

(57) ABSTRACT

Encapsulated oil and fat products with protein and carbohydrate ingredients are provided, in which the free fatty acids in the oils and fats are required from 5 to 100% on a solids basis. The oils and fats can be from plant or animal source. The oils and fats with free fatty acids 5-100% may be encapsulated with protein and carbohydrate ingredients to form encapsulated products under a heat treatment above 65° C. The lipid in the encapsulated may be less than 80% on a solids basis. The encapsulated oil and fat products may be used as food, feed and other ingredients, which are easily handed and packaged with longer shelf life. In ruminant feed, the encapsulated products may have the by-pass function.

### BACKGROUND OF THE INVENTION

There are several benefits for oil and fat encapsulated products. The products can be easily handed and packaged as food and feed ingredients. The dry products can be stored for longer time. In ruminant feed, encapsulated products may pass through rumen substantially unchanged for subsequent digestion in the abomasum and lower gut of the ruminant animal, which may increase the milk production for dairy cows.

Over the years, various attempts have been made to make lipid, which usually contains oil and fat, encapsulated products. A number of patents have been issued to make the fat encapsulated products by some special treatments and pH change treatments. U.S. Pat. No. 6,436,461 discloses a process to prepare the gel beads containing acid polysaccharide (carbohydrate) and voltaile liquid ingredient by forming of discrete droplets and converting the droplets to water-insoluble gel beads by introducing the droplets in a solution with multivalent cations. The ingredient consists flavors, fragrances, vitamins or coloring materials. U.S. Pat. No. 6,229,031 discloses a process method for the preparation of fatty acid calcium salt, which can be used as rumen bypass feed supplements. Fatty acid, calcium oxide and water is heated to a temperature at which the fatty acid glycerides saponify to form fatty acid calcium salt. U.S. Pat. No. 5,874,102 discloses a process to prepare a dietary fatty acid salt product in granulated form, which can function as a rumen bypass animal feed supplement. U.S. Pat. No. 6,153,236 discloses a process for low melt encapsulation with high laurate canola oil. U.S. Pat. No. 5,514,388 discloses a process to treat protein with a base to increase the pH to such as 12 at first. Then the fat is added into the alkali protein. The protein firm gel product is formed when the pH is lowed to 3 to 5. U.S. Pat. No. 5,143,737 discloses a process method to produce unsaturated milk fat or meat fat to be encapsulated with nontoxic crosslinkable material. U.S. Pat. No. 4,808,429 discloses a process to encapsulate animal blood and fat by heating to a temperature in the range 40-45 degree ° C. and homogenizing into a dispersion or emulsion. Then the mixture was allowed to cool and to form a gel product. U.S. Pat. No. 4,217,370 discloses a process to treat protein with a base to increase the pH such as 11 at first. Then the fat is added into the alkali protein. The protein and fat are mixed together before any pH change. The protein-fat gel product is formed when the pH is lowed to the isoelectric point. U.S. Pat. No. 4,216,234 discloses a process to render albumin containing medium with strongly alkaline (e.g. pH 11) prior to the formation of the fat dispersion or emulsion. The fat is encapsulated to form a gel-form product. U.S. Pat. No. 4,138,505 discloses a process to heat animal blood to a temperature in the range of from about 20 to about 60° C., to adjust the pH of the heated aqueous medium to a strongly alkaline such as pH 12 to form a blood solid gel, and thereafter recovering the fat-protein gel. In pH change treatments, ash level is increased significantly in the final products because of base or acid involved in the processes. Fat and oil may become soap at strongly alkaline. Also the formed products by pH change is not easily controlled. The viscosity is very high. There is a need for a practical and inexpensive process, which can be easily scaled up into the production to make the oil and fat encapsulated complex product with protein, carbohydrate or protein and carbohydrate ingredients. It is very important to commercialize the processes.

It has been found by this present invention that oil or fat products with free fatty acids (5-100%) can be encapsulated easily by protein, carbohydrate or protein and carbohydrate ingredients through a heat treatment. The purpose of the present invention is to provide a simple heat process for the preparation of oil or fat (with free fatty acids 5 to 100%) encapsulated products. The encapsulated products have no oily physical characteristics even though the products have high fat level such as 50% on a solids basis. Heat process such as direct steam injection process may be a very simple, economic and practical method to form protein or carbohydrate gels for encapsulating oil or fat products.

### SUMMARY OF THE INVENTION

The present invention overcomes the problems of other patents and provides a process to form lipid-protein, lipid-carbohydrate or lipid-protein-carbohydrate encapsulated products by the simple heat treatment.

Lipid usually contains oil and fat. The oils and fats can be from plant or animal source such as soy free fatty acid oil, animal fat, fish oil, conjugated linoleic acid oil and others. Oil and fat ingredients with free fatty acid level at least 5% or up is required for this encapsulated process.

The typical conjugated linoleic acid oil usually has 90-99% free fatty acids. Normal animal fat has less than 2% free fatty acids. Some animal fat (special processed animal soap fat) has high free fatty acid level such as more than 20%. Soybean oil has less than 1% free fatty acid. Soybean oil by-product—soy free fatty acid oil or soy soap has 30-70% free fatty acids. These oil and fat ingredients can be from the food industry. There also are other oil and fat products with wide range of free fatty acids from chemical and other industries. There are number of oil and fat products, which have free fatty acids from 5 to 100%. Conjugated linoleic acid (CLA) oil is a relative new product, which relates to human and animal health, animal meat quality and milk quality. U.S. Pat. Nos. such as 6,203,843, 5,554,646, 5,430,006 and 5,428,072 are related to conjugated linoleic acid (CLA) products.

Protein and carbohydrate ingredients come from different plant and animal sources such as soy, corn, wheat, plasma, animal blood, albumin fraction, yeast, milk protein, casein, whey protein concentrate, cotton seed meal, agar, cellulose, starch, polysaccharide gum and others, which may form the gel and coagulation under heat treatment. Wheat gluten, plasma, casein, animal blood and soy protein are protein ingredients, which can be used to encapsulate the oil and fat ingredients to form high protein and high fat level products. Agar, cellulose, starch and polysaccharide gum are carbohydrate ingredients, which also can be used to encapsulate the oil and fat ingredients to form high carbohydrate and high fat level products. Some ingredients such as soy meal and corn meal contain protein and carbohydrate. Different nutritional values can be matched by the mixture of these ingredients at certain rates.

A oil or fat ingredient is mixed with a protein, carbohydrate or protein and carbohydrate ingredient. For preventing product lipid oxidation, some food or feed grade chemicals may be added into the mixture. It is not necessary to change the pH value in most cases, which range from 4 to 10. The pH value may be changed to such as about neutral pH 7 in some cases for the best encapsulation, which is totally different from changing to strong alkaline such as pH 12 in some of above patents. Fat and oil may become soap at strongly alkaline. Besides the lipid (oil or fat) ingredient is required to have free fatty acids 5-100% on a solids basis, a heat source such as direct heat injection or indirect heat exchange is also required to encapsulate the mixture to form lipid-protein, lipid-carbohydrate or lipid-protein-carbohydrate gel products.

The wet lipid-protein, lipid-carbohydrate or lipid-protein-carbohydrate product with moisture (e.g. 40-80%) may be used in the applications without any further drying process. Also the wet lipid-protein, lipid-carbohydrate or lipid-protein-carbohydrate product may be dried into a dry form with a common dryer such as air bed dryer, spray dryer, and 3-pass drum dryer. The dry product has no oily physical characteristics. The dry product may be stored for longer time.

Two or more oil, fat, protein or carbohydrate ingredients may be mixed for preparing the oil and fat encapsulated products. Besides oil, fat, carbohydrate and protein ingredients, other ingredients or nutrients such as minerals and vitamins may also be added into the mixture for nutritional and other reasons. Besides the nutritional applications, there may be other applications for the fat or oil encapsulation process in this invention such as in organic medicine agent encapsulation for slow release. The hydrophobic regions of free fatty acids in fat or oil ingredient bind to the organic medicine agents by hydrophobic bond after the fat or oil ingredient with free fatty acids (5-100%) is mixed with the organic medicine agents. The hydrophilic regions of free fatty acids bind to protein or carbohydrate ingredients and then the hydrophobic regions of free fatty acids and the organic medicine agents are encapsulated by the protein or carbohydrate ingredients during the heat process. The encapsulated organic medicine agents have the function to release slowly in human or animal body. This encapsulated process in this invention is more practical for large-scale production than the cross-linked carbohydrate product with even toxic cross-linking chemicals as a matrix for the slow release of medicine agents, which are described in such as U.S. Pat. Nos. 6,419,957 and 5,456,921. The present oil and fat encapsulated process is an more easy and economic process, which may make the encapsulation process easily commercialized.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

### Soy Meal and Conjugated Linoleic Acid

Soy meal powder (27 grams) was mixed with water (39 grams). Then conjugated linoleic acid oil (21 grams) was mixed with the soy meal. Then mixture was mixed and heated to 80° C. with a mixer for 5 minutes. The mixture was dried in an oven at 105° C. for 3 hours. The product was yellowish color particles. The analytical data were as follows: protein (31.3%), moisture (6.0%), fat (40.6%), and ash (3.8%).

### EXAMPLE 2

### Animal Fat, Animal Blood and Corn Meal

Corn meal powder (30 grams) was mixed with turkey whole blood (42 ml) and animal fat (20 grams). The mixture was mixed and heated to 85° C. with a mixer for 4 minutes. The mixture was dried in an oven at 105° C. for 5 hours. The analytical data were as follows: protein (21.4%), moisture (2.8%), fat (32.8%), and ash (5.4%).

### EXAMPLE 3

### Wheat Gluten and Conjugated Linoleic Acid

Wheat gluten powder (33 grams) was mixed with 60 grams of water. Then conjugated linoleic acid oil (26 grams) was mixed with the wheat gluten. The mixture was mixed and heated to 85° C. with a mixer for 6 minutes. The mixture was dried in an oven at 105° C. for 3 hours. The resulting solid was ground into a yellowish color powder. The analytical data were as follows: protein (35.7%), moisture (3.6%), fat (41.6%), and ash (2.5%).

### EXAMPLE 4

### Cotton Seed Meal, Animal Fat and Chicken Blood

Cotton seed meal (50 grams) was mixed with chicken whole blood (140 ml) and animal fat (60 grams). The mixture was mixed and heated to 80° C. with a mixer for 3 minutes. The mixture was dried in an oven at 105° C. for 5 hours. The analytical data of the product were as follows: protein (36.4%), moisture (2.0%), fat (39.6%), and ash (5.4%).

### EXAMPLE 5

### Plasma and Conjugated Linoleic Acid

Bovine plasma with 18% solid (261 grams) was mixed with Rigel 1005 (0.5 grams), conjugated linoleic acid (51 grams) and Rigel 1015 (0.3 grams). The mixture was mixed and heated to 80° C. with a mixer for 6 minutes. The mixture was dried in an oven at 105° C. for 3 hours. The analytical data of the product were as follows: protein (37.6%), moisture (2.3%), fat (48.7%), and ash (5.9%).

### EXAMPLE 6

### Animal Blood and Soy Free Fatty Acid Oil

Chicken whole blood (330 ml) was mixed with Soy Free Fatty Acid Oil (90 g), Rigel 1005 (1.2 grams), Rigel 1010 (0.5 ml) and Rigel 1003 (2.5 ml). The mixture was mixed and heated to 85° C. for 6 minutes. The mixture was dried in an oven at 105° C. for 3 hours. The analytical data were 5 as follows: protein (32.9%), moisture (3.0%), fat (55.1%), and ash (4.2%). The product was no lipid rancid smell after stored for 90 days in the summer.

### EXAMPLE 7

### Carbohydrate and Soy Free Fatty Acid Oil

Carbohydrate agar (34 g) was mixed with water (130 g) and soy free fatty acid oil (60 g), and Rigel 1010 (0.5 ml). The mixture was dried in an oven at 105° C. for 4 hours. The analytical data were as follows: moisture (6.2%), fat (33.8%), and ash (5.1%). The product had no oily physical characteristics.

What is claimed is:

1. A method of preparing a oil or fat encapsulated product comprising mixing a oil or fat ingredient at free fatty acid level from 5% to 100% on a solids basis with a protein ingredient and then heating the mixture to a temperature above 65° C. to form the product.

2. The method of claim 1 wherein the protein ingredient is from plant and animal sources.

3. The method of claim 1 wherein the encapsulated product is wet or dry form.

4. The method of claim 1 wherein the encapsulated product has no oily physical characteristics.

5. A method of preparing a oil or fat encapsulated product comprising mixing a oil or fat ingredient at free fatty acid level from 5% to 100% on a solids basis with a carbohydrate ingredient and then heating the mixture to a temperature above 65° C. to form the product.

6. The method of claim 1 wherein the carbohydrate ingredient is from plant and animal sources.

7. The method of claim 1 wherein the encapsulated product is wet or dry form.

8. The method of claim 1 wherein the encapsulated product has no oily physical characteristics.

9. A method of preparing a oil or fat encapsulated product comprising mixing a oil or fat ingredient at free fatty acid level from 5% to 100% on a solids basis with a protein and carbohydrate ingredient and then heating the mixture to a temperature above 65° C. to form the product.

10. The method of claim 1 wherein the protein and carbohydrate ingredient is from plant and animal sources.

11. The method of claim 1 wherein the encapsulated product is wet or dry form.

12. The method of claim 1 wherein the encapsulated product has no oily physical characteristics.
